(19) United States
(12) Patent Application Publication
(10) Pub. No.: US 2025/0350398 A1
(43) Pub. Date: Nov. 13, 2025

(54) Frame length obfuscation methods to increase the privacy of STAs in 802.11 Networks

(71) Applicant: InterDigital Patent Holdings, Inc., Wilmington, DE (US)

(72) Inventors: Antonio DE LA OLIVA, MADRID (ES); Joseph LEVY, New York, NY (US); Robert GAZDA, Conshohocken, PA (US); Rui YANG, Melville, NY (US)

(21) Appl. No.: 18/661,027

(22) Filed: May 10, 2024

(51) Int. Cl. H04L 1/00; H04W 80/02

(52) U.S. Cl. CPC H04L 1/0007; H04W 80/02

(57) ABSTRACT

Methods and apparatuses are disclosed that provide for the protection of the privacy of individuals using wireless local area network (WLAN) technologies and protecting the identification of WLAN users of networks implementing IEEE 802.11 standards by frustrating attempts at traffic analysis that may compromise user privacy. Methods and apparatuses disclosed include randomly modifying the length of medium access control service data units (MSDUs) such that all frames sent/received among stations (STAs) associated with a particular access point (AP) are the same length such that all traffic appears the same to an observer. Other methods disclosed may include random padding of the MSDUs, and/or fragmenting/segmenting MSDUs. Finally, embodiments of a method are disclosed in which a new element is used to signal epoch parameters to a group or a single STA, identified by their Association Identifier (AID) via groupcast or broadcast, thereby preventing collisions that would result using conventional unicast techniques.

### BACKGROUND

There has been recent interest in providing new mechanisms for the protection of the privacy of individuals using wireless local area network (WLAN) technologies. A main area of endeavor in this regard has been protecting WLAN users from those who track them-including protecting the possible identification of the WLAN users as they roam to different locations and different networks implementing IEEE 802.11, a set of standards that define how WLANs (i.e., Wireless Fidelity (WiFi) operate.

### SUMMARY

One or more of the foregoing issues or needs may be addressed by aspects of the embodiments disclosed herein.

In certain aspects, embodiments of a method are disclosed for a station (STA), the method comprising: randomly modifying the length of medium access control service data units (MSDUs) such that all frames sent/received among stations (STAs) associated with a particular access point (AP) are the same length. In this inventive manner, all traffic appears the same to an observer, thereby frustrating attempts at traffic analysis and compromising of user privacy.

In certain other aspects, embodiments of a method are disclosed in which a random length (RL), enhanced privacy (EP), MSDU is extended in length by the inclusion of a header indicating the real size of the MSDU.

In still certain other aspects, embodiments of a method are disclosed in which the length of the MSDUs are extended by adding random padding.

In certain aspects, embodiments of a method are disclosed in which a transmitting STA may divide or fragment/segment an MSDU prior to transmission and then transmit the set of fragments/segments.

Finally, in certain aspects, embodiments of a method are disclosed in which a new element is used to signal epoch parameters to a group or a single STA, identified by their Association Identifier (AID) via groupcast or broadcast, thereby preventing collisions that would result using conventional unicast techniques.

Additional aspects are also disclosed.

One or more embodiments also provide a computer program comprising instructions which when executed by one or more processors cause the one or more processors to perform the methods according to any of the embodiments described herein.

### BRIEF DESCRIPTION OF THE DRAWING

A more detailed understanding may be had from the following description, given by way of example in conjunction with the accompanying drawing, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram of an example wireless local area network (WLAN) in which one or more disclosed embodiments may be implemented;

FIG. 3 shows an illustrative Random Length, Enhanced Privacy, Medium Access Control Service Data Unit (RL EP MSDU) header according to aspects of the present disclosure;

FIG. 4 shows an illustrative Enhanced Privacy payload length field of the RL EP MSDU of FIG. 3 when fragmentation is employed to reduce the size of the MSDU according to aspects of the present disclosure;

FIG. 5 shows an illustrative Random Length, Enhanced Privacy, Protocol Version 0, Counter Mode with CPC-MAC Protocol Data Unit (RL EP PV0 CCMP MPDU) according to aspects of the present disclosure;

FIG. 6 shows an illustrative RL EP PV1 CCMP MPDU having expanded data payload to increase privacy according to aspects of the present disclosure;

FIG. 7 shows a flow diagram of an illustrative transmission procedure for the obfuscation by increasing the MSDU length prior to transmission according to aspects of the present disclosure;

FIG. 8 shows a flow diagram of an illustrative reception procedure for an obfuscated MSDU having increased length according to aspects of the present disclosure;

FIG. 9 shows a flow diagram of an illustrative procedure for obfuscating the length of packets by dividing by fragmentation or segmentation of the MSDU according to aspects of the present disclosure;

FIG. 10 shows a flow diagram of an illustrative reception procedure for an obfuscated MSDU having increased length and is fragmented/segmented according to aspects of the present disclosure;

FIG. 11 shows an illustrative Enhanced Privacy Epoch Information element format according to aspects of the present disclosure;

FIG. 12 shows an illustrative Epoch Information field format according to aspects of the present disclosure;

FIG. 13 shows an illustrative Enhanced Privacy Epoch parameters element according to aspects of the present disclosure;

FIG. 14 shows an illustrative list of Association Identifier (AID) parameter assignments field according to aspects of the present disclosure;

FIG. 15 shows an illustrative AID parameter assignment subfield according to aspects of the present disclosure;

FIG. 16 shows an illustrative EP AID parameter assignment control field according to aspects of the present disclosure;

FIG. 17 shows an illustrative AID map subfield in case AID may type is set to 2 according to aspects of the present disclosure;

FIG. 18 shows an illustrative AID map subfield in case AID map type is set to 3 according to aspects of the present disclosure; and

FIG. 19 shows an illustrative AID map subfield in case AID map type is set to 4 according to aspects of the present disclosure.

### DETAILED DESCRIPTION

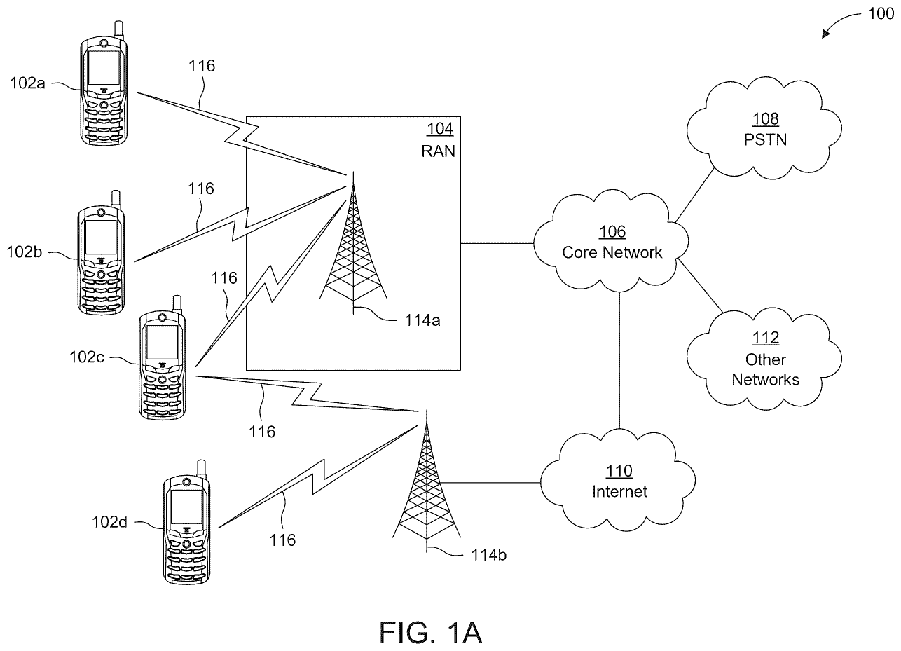

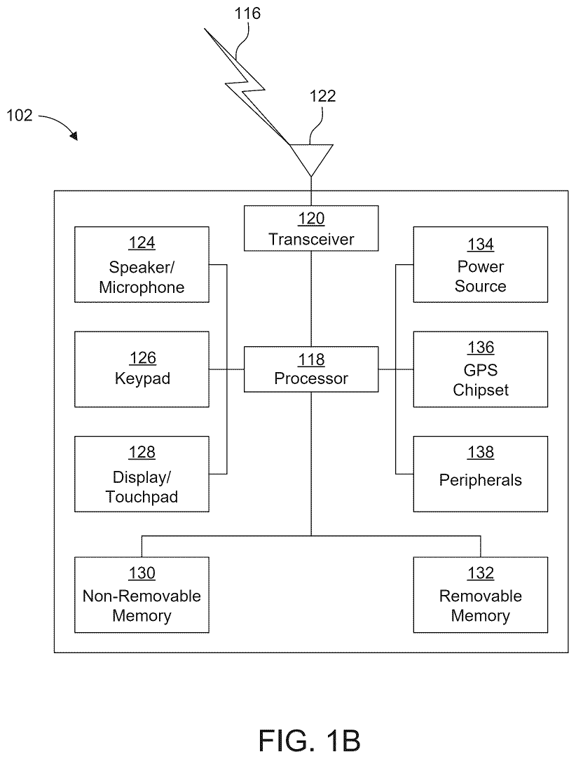

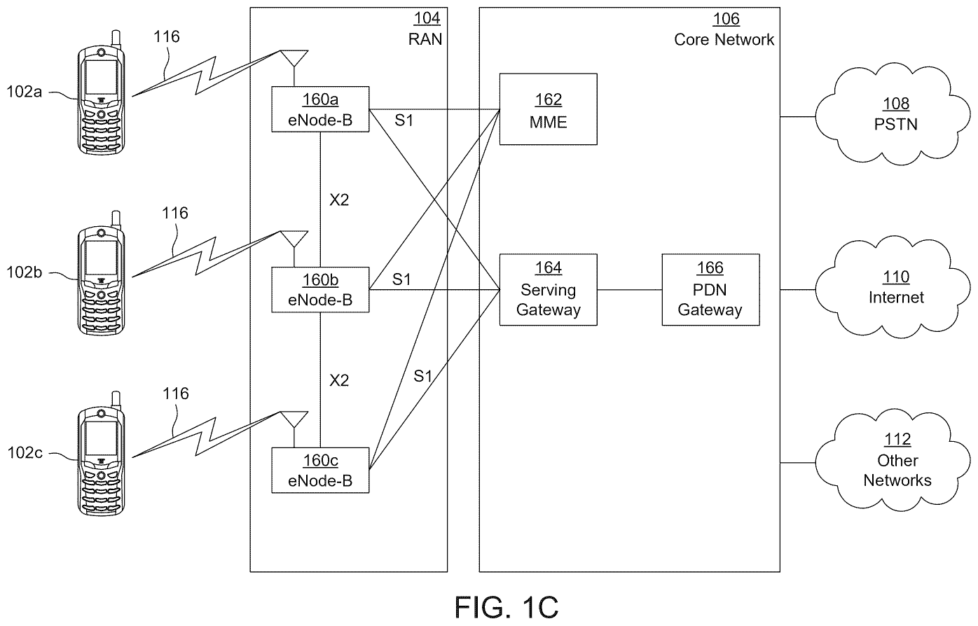

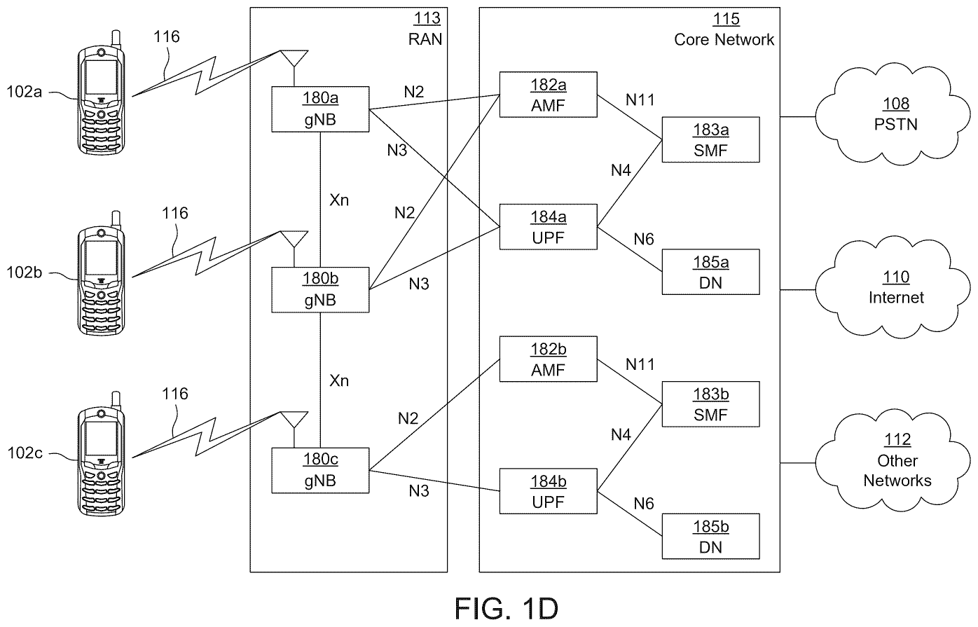

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor, a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHZ, 80 MHZ, and/or 160 MHz wide channels transmitted over a 5 GHz frequency band using OFDMA. The 40 MHZ, and/or 80 MHZ, channels may be formed by combining contiguous 20 MHz channels. A 160 MHz channel may be formed by combining 8 contiguous 20 MHZ channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHZ, 80 MHZ, and/or 160 MHz wide channels capable of transmission over 2.4 GHz, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHZ and 6 GHZ) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave-IMMW), energy harvesting based on of WiFi RF signals for facilitating WLAN communications of low-power IoT devices, and the randomization of MAC addresses in WLANs.

### MAC Privacy Enhancements

As previously noted, there has been recent interest in providing new mechanisms for the protection of the privacy of WLAN users from those who track them. Consequently, several modifications to the IEEE 802.11aq baseline specification were introduced to support MAC Privacy features. These features focus on protecting the privacy of the user in a non-associated state. We note that for this disclosure we consider the baseline specification as IEEE 802.11-2020, and new work starting in IEEE 802.11bi and IEEE 802.11bh.

Several characteristics of IEEE 802.11 networks can be employed to track users. Prior to the MAC Privacy enhancements being added to the base line specification, a STA used a hard-wired (device unique) MAC address for all associations. Since a STA defines a MAC address to be used for an association to an AP, it is trivial for the STA to be tracked, as merely observing the MAC address in pre-association and post-association messages allowed the tracking of the STA. Note that the MAC address is present in all transmissions sent by the STA and is not encrypted or protected from observation in any manner.

In addition to the MAC address, there are other 802.11 characteristics that can be used to track a STA in IEEE 802.11 networks. For example, each frame in a sequence of frames sent by the STA to an AP has a sequence number in a MAC header that also is not encrypted or protected from observation in any manner. As a result, even if a transmitting STA changed its MAC address, the sequence number can be used to track the STA, since consecutive frames sent by the transmitting STA have consecutive sequence numbers. Still other 802.11 characteristic mechanisms such as Orthogonal Frequency Division Multiplexing Physical Data scrambling (OFDM PHY DATA)—while arguably more complex—are nevertheless vulnerable to tracking if the OFDM PHY DATA scrambler is not reseeded.

The MAC Privacy enhancements introduced into the standard enabled the STA to modify these parameters in pre-association state, in such a way that a user cannot be trivially tracked while it roams before associating to an AP or when it changes network access.

As indicated in the modified standard, the MAC Privacy enhancements “ . . . to mitigate this sort of traffic analysis a STA can support the ability to periodically and randomly change its MAC addresses and reset counters and seeds prior to association. While discovering networks, a STA can refrain from gratuitously transmitting Probe Request frames containing SSIDs of favored BSS networks.”

### Requirements for Support of MAC Privacy Enhancements

The baseline specification defines a set of requirements for applying MAC address randomization:
The STA may periodically change its MAC address to a random value while not associated to a BSS.
The STA may construct the randomized MAC address from the locally administered address space as defined in IEEE Std 802-2014 and IEEE Std 802c-2017.
The non-AP STA may not change its MAC address during a transactional exchange, for example, transmitting Public Action frames for pre-association discovery, or during the creation of state on an AP using pre-association capabilities, for example, RSN pre-authentication or FT over-the-DS.
If a non-AP STA starts any transaction that establishes state bound to a MAC address and decides to establish an association or a transaction state with a discovered BSS, it may change the MAC address to the one used to establish this state.
State created with an AP using a prior MAC address, for instance, RSN pre-authentication state or FT state established over-the-DS, is bound to the MAC address used when that state was created.
Every time a MAC address is changed to a new random value, counters in all sequence number spaces used to identify each frame must be reset.
The non-AP STA connecting to an infrastructure BSS may retain a single MAC address for the duration of its connection across an ESS.

Although the MAC Privacy enhancements introduced into the standard do improve user privacy, further improvements to user privacy are necessary as well as improvements to the operation of 802.11 networks where MAC address randomization is employed. In recognition of these needs, IEEE 802.11bi specifies modifications to the IEEE Std 802.11 MAC to include new mechanisms that address and improve user privacy, while IEEE 802.11bh specifies modifications to MAC mechanisms to preserve existing services that might otherwise be restricted in environments where STAs in an ESS use randomized or changing MAC addresses, without affecting user privacy. IEEE 802.11bh will work on mechanisms to enable session continuity in the absence of any unique MAC address-to-STA mapping.

### Problem Statement

This disclosure provides inventive methods and structures that solve problems being identified in IEEE 802.11bi, providing mechanisms that broaden the operation space of MAC Privacy enhancements and extending privacy features explored in IEEE 802.11bi.

First, current proposed solutions consider mechanisms avoiding the identification of STAs by analysis of traffic patterns, specifically avoiding the matching of packet/frames sizes to flow types and therefore allowing these flows to identify the STA transmitting them.

Possible rationale behind these approaches arises from the fact that even when the STA is rotating its MAC address during association, it is possible to identify the STA by analyzing the type of traffic sent (through characteristics such as periodicity, packet sizes, etc.). The ability to use this type of analysis to identify the STA is simplified when there are only a limited number of STAs connected to the AP, and the amount of traffic in the network is not voluminous.

As those skilled in the art will understand and appreciate, IEEE 802.11 uses different frames for the transmission of data. Consequently, in this disclosure we have analyzed the use of MAC Service Data Units (MSDUs), Aggregate MAC Service Data Units (A-MSDUs), MAC Protocol Data Units (MPDUs) and Aggregate MAC Protocol Data Units (A-MPDUs), as follows:
Medium access control (MAC) service data unit: [MSDU] Information that is delivered as a unit between MAC service access points (SAPs). A fundamental unit of data transmitted within a network, specifically at Media Access Control layer.
Aggregate medium access control (MAC) service data unit: [A-MSDU] A structure that contains one or more MSDUs and is transmitted in one or more QoS Data frames with the same sequence number. A technique that improves efficiency by combining multiple MSDUs into a single transmission unit.
Medium access control (MAC) protocol data unit: [MPDU] The unit of data exchanged between two peer MAC entities using the services of the physical layer (PHY).
Aggregate medium access control (MAC) protocol data unit: [A-MPDU] A structure that contains one or more MPDUs and is transported by a physical layer (PHY) as a single PHY service data unit (PSDU). A-MPDUs are efficiency boosters used in 802.11n networks—and later—to bundle MPDUs (including regular MPDUs and even A-MDUs) into a single, larger transmission unit.

MSDUs may be aggregated in A-MSDUs, which are encapsulated in MPDUs or A-MPDUs. When considering confidentiality, i.e., in the case when the frames are encrypted, the content of an MSDU is protected from an external observer, however its length is visible.

In the case of an A-MSDU, multiple MSDUs are aggregated and transported with a single MAC header. A third-party observer of an A-MSDU will not be able to determine if an A-MSDU carries one or more MSDUs, or to differentiate their individual length.

MPDUs may carry one MSDU or multiple MSDUs through an A-MPDU. An A-MPDU encapsulates multiple MPDUs (that may carry one MSDU of multiple through A-MSDUs) each with a separate header.

Even in the case when the A-MPDU is protected, the headers of each A-MPDU subframe are not protected. As such, an external observer can simply observe how many MPDUs are carried in the A-MPDU and their individual length. This observable information may be used to perform traffic analysis to track an individual STA.

Considering the above, in this disclosure we describe randomly modifying the length of an MSDU, which is the minimum element that may be transmitted between two end points and has an observable length that may be observed by an external observer.

Through the modification of the MSDU length, an AP may enforce that all associated EP STAs use the same frame length. In this inventive manner all traffic appears the same to an external observer, making it harder for that external observer to perform traffic analysis.

Additionally, there are some parameters which may also help an EP STA to maintain its privacy. For example, mechanisms related to the rotation of MAC addresses largely depend on the number of EP STAs rotating their addresses in a coordinated way. Therefore, it would be useful for the EP STAs to know how many EP STAs, that are rotating their MAC addresses, are associated to the AP.

Finally, current approaches about how to signal parameters to be modified at the epoch boundary, assume that the AP will signal in unicast the next value of AID to each STA. As those skilled in the art will understand and appreciate, such an approach may pose scalability problems, since depending on the frequency of the MAC change it may require that thousands of messages be exchanged every few seconds.

### Definitions

In this disclosure we will use the term random-length (RL) EP MSDU to indicate an MSDU which may be increased or decreased in length to reduce the ability of the MSDU length to be used to perform traffic analysis.

We will use the term secure random-length (RL) EP MPDU/A-MPDU to indicate a protected MPDU/A-MPDU carrying RL EP MSDUs.

In this disclosure we may consider an STA transmitting MSDUs of a specific size L. Before transmitting the MSDU, the transmitting STA may randomly modify the size of the MSDU thereby protecting it from packet size analysis. The STA may increase the length of the MSDU by P bytes, to a total length of L+P. The number of bytes to be included as Padding (P) may be **randomly** changed on a per frame basis. In all cases, the STA may append to the MSDU an EP header. The STA may decrease the length of the MSDU by using segmentation or fragmentation to divide the MSDU or A-MSDU and send it in more than one PSDU. Finally, the STA may increase the length of the divided portion of the MSDU by applying padding as noted previously.

### Solutions

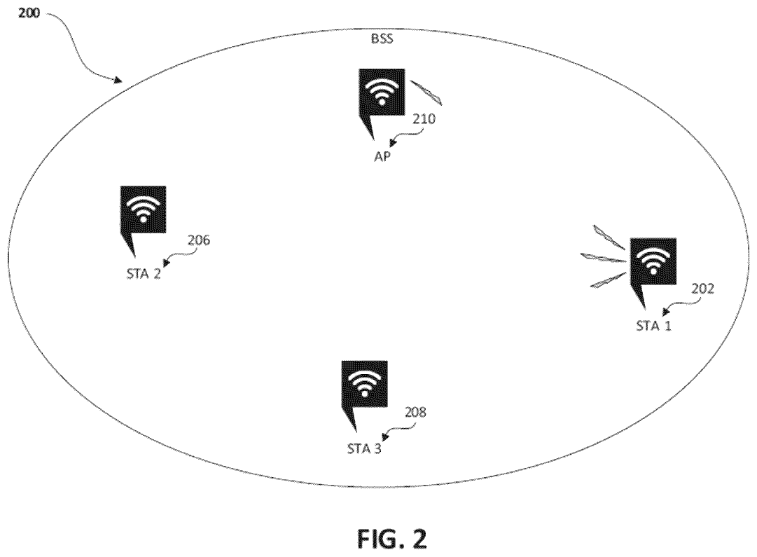

FIG. 2 shows an example WLAN 200 including a STA 202, a STA 206, a STA 208, and an AP 210. The WLAN 200 is in Infrastructure Basic Service Set (BSS) mode, with the STAs 202, 206, and 208 and the AP 210 considered to constitute a BSS. In the illustrative scenario depicted in FIG. 2, the STA 202 has transmitted a MAC Service Data Unit (MSDU), Aggregate MAC Service Data Units (A-MSDU), MAC Protocol Data Units (MPDU) or Aggregate MAC Protocol Data Units (A-MPDU). As illustratively shown in the figure, the individual the STAs use MSDUs and/or MPDUs to transmit traffic. Accordingly any of the MSDUs and/or MPDUs may be so used to provide such transmission of traffic.

### EP Header

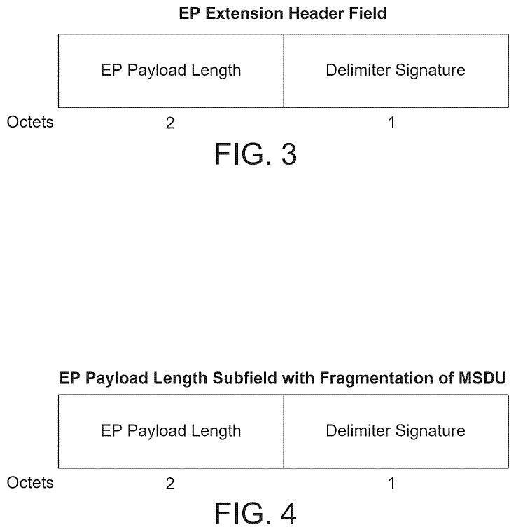

FIG. 3 shows an illustrative Random Length, Enhanced Privacy, Medium Access Control Service Data Unit (RL EP MSDU) header according to aspects of the present disclosure. As shown in that FIG. 3, the illustrative RL EP MSDU header is extended by inclusion of a header indicating the size of the MSDU-without length modification. More specifically, the illustrative RL EP MSDU includes an EP Payload length subfield that is shown as two (2) octets in length and a Delimiter signature subfield that is shown as one (1) octet in length. The EP payload length subfield may contain the length in bytes of the original MSDU which is extended while the Delimiter signature subfield may contain a pattern (signature) that may be used to detect an EP header when scanned.

FIG. 4 shows an illustrative RL EP MSDU header according to aspects of the present disclosure in which the MSDU is fragmented. As shown in that FIG. 4, if fragmentation is employed to reduce the size of the MSDU, the EP Payload length subfield may provide the number of fragments the original MSDU has been fragmented into. As illustratively shown, such EP Payload length subfield is further divided into two additional subfields, an EP number of fragments subfield having a length of one (1) octet and an EP Fragment length subfield having a length of one (1) octet in length.

### Random-Length Enhanced Privacy MPDU by Padding

As previously noted, one aspect of the present disclosure describes methods and structures that randomly modify the size of MSDUs transmitted by an STA. In so doing, additional complexity as perceived by an external observer attempting to identify traffic types is introduced. By artificially modifying the length of the frames, it is very difficult or impossible for an observer to perform statistical analysis of the underlying traffic, making it impossible to detect what kind of traffic is being exchanged. According to an aspect of the present disclosure, the MSDUs may be extended in length by adding padding, prior to encryption of the frame. As used in this disclosure, padding refers to extra bits or data added to a frame or other unit of data to achieve specific goals. Common uses of padding include maintenance of frame size, and synchronization and efficiency. In our inventive method, padding is added to an MSDU to extend its length, advantageously frustrating observers of the MSDU from identifying a traffic type to which it belongs.

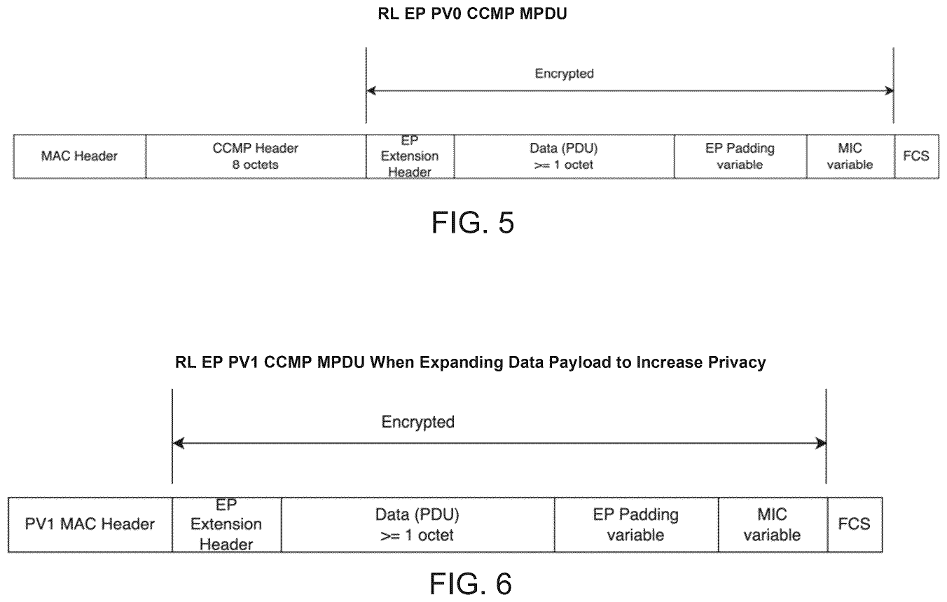

FIG. 5 shows an illustrative Random Length, Enhanced Privacy, Protocol Version 0, Counter Mode with CPC-MAC Protocol Data Unit (RL EP PV0 CCMP MPDU) according to aspects of the present disclosure. With reference to that FIG. 5, it may be observed that the illustrative RL EP PV0 CCMP MPDU according to aspects of the present disclosure may include the following fields namely, MAC header, CCMP Header, EP Extension Header, Data (PDU), EP Padding, Message Integrity Check (MIC), and Frame Check Sequence (FCS). Shown further is that the EP Extension Header, Data, EP Padding, and MIC fields are encrypted prior to transmission while the MAC Header, CCMP Header, and FCS fields are not. Shown still further is that the CCMP Header is 8 octets in length, the Data (PDU) is >=1 octet in length, the EP Padding is variable length, and the MIC is variable length.

The EP Extension Header includes information about the length of the Data (PDU) or Data (PDU)+MIC fields. As may be readily understood by those skilled in the art, the EP Extension Header is appended to the MSDU and encrypted along with it to form the encrypted part of the EP PV0 CCMP MPDU.

The MPDU also contains an EP Padding field which expands the length of the MPDU with randomly generated bytes which may be obtained from the PRF function. The length of the encrypted MPDU to an external observer includes the EP Extension Header, the Data, the EP Padding field, and the MIC. This length is not the same as the length of the encrypted MPDU that would have been sent without the random-length enhanced privacy enhancement and is therefore less trackable by traffic analysis.

FIG. 6 shows an illustrative Random Length, Enhanced Privacy, Protocol Version 1, Counter Mode with CPC-MAC Protocol Data Unit (RL EP PV1 CCMP MPDU) having an expanded data payload to increase privacy according to aspects of the present disclosure. With reference to that FIG. 6, it may be observed that the illustrative RL EP PV1 CCMP MPDU according to aspects of the present disclosure may include the following fields namely, PV1 MAC header, EP Extension Header, Data (PDU), EP Padding, Message Integrity Check (MIC), and Frame Check Sequence (FCS). The PV1 MAC Header corresponds to the MAC Header and CCMP Header shown in the RL EP PV0 CCMP MPDU frame above.

Shown further is that the EP Extension Header, Data, EP Padding, and MIC fields are encrypted prior to transmission while the MAC Header, CCMP Header, and FCS fields are not. Shown still further is that the CCMP Header is 8 octets in length, the Data (PDU) is >=1 octet in length, the EP Padding is variable length, and the MIC is variable length.

The EP Extension Header includes information on the length of the Data (PDU) or Data (PDU)+MIC and is appended to the MSDU and encrypted with it to form the encrypted part of the EP PV1 CCMP MPDU. The MPDU also includes an EP Padding field which expands the length of the MPDU with randomly generated bytes which may be obtained from a pseudo-random function (PRF). Note that the PRF is deterministic. As a result, given the same input, it will produce the same result. Note further that the EP Padding field may be identified as part of the Encrypted MPDU by an external observer.

For a receiving STA to be able to process a transmitted frame correctly, it is important to signal the use of the EP Extension header within the encrypted frame body. This may be done in several ways:
Create a new type of data frame, the EP data frame, by assigning a value in Table 9-1 of IEEE 802.11REVme/D4.2, for example using the type 10 (for data) and the subtype 0001 which is now reserved.
Use the Delimiter Signature included in the EP Extension header. After decryption, check the corresponding position in the bitstream where the Delimiter signature on the EP Extension header may be. In case it is found, assume there is an EP Extension header in the frame.

### Procedure for the Obfuscation by Increasing the MSDU Length

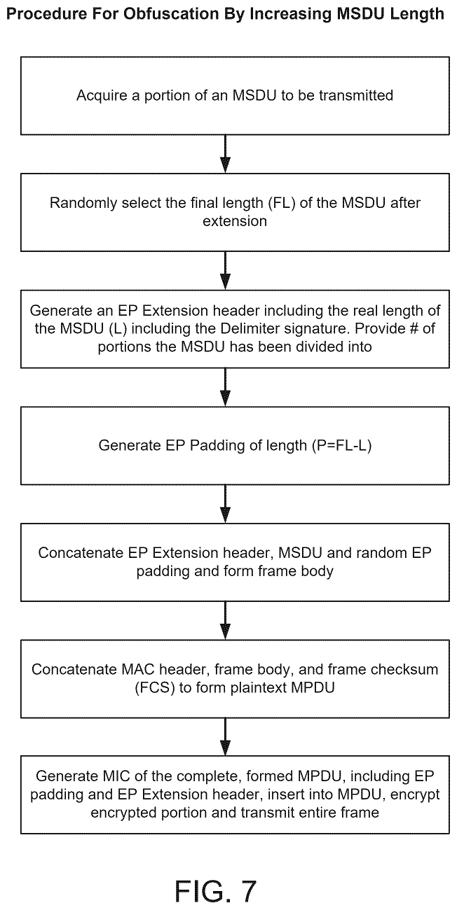

A transmitting STA desiring to improve its privacy by obfuscating the length of packets used for certain traffic may divide an MSDU by fragmentation or segmentation. FIG. 7 shows a flow diagram of an illustrative procedure for the obfuscation by increasing the MSDU length according to aspects of the present disclosure. The illustrative procedure is performed for each portion of the MSDU transmitted. We note that the EP header is included in a plain text frame undergoing cyphering and not added later.

Given a portion of an MSDU to be transmitted, randomly select the final length (FL) of the MSDU after extension. This may be done using one of the Pseudo Random Functions (PRFs) defined in IEEE 802.11.

While forming the plaintext MPDU, generate an EP Extension header including the real length of the MSDU (L) and including the Delimiter signature defined for this usage and provide the number of portions the MSDU has been divided into.

Generate an EP Padding of length (P=FL−L). The random padding may be obtained through multiple iterations of a PRF.

Concatenate the EP Extension header, MSDU and random padding to form the Frame Body.

Concatenate the MAC header, Frame Body, and FCS to form the plaintext MPDU.

It is important that the RL EP MPDU contains the EP Extension header and its associated EP Padding before ongoing protection. The MIC may be computed of the complete expanded MSDU, including the EP Padding and EP Extension header. This is to be able to decapsulate the plain text portion MPDU in reception.

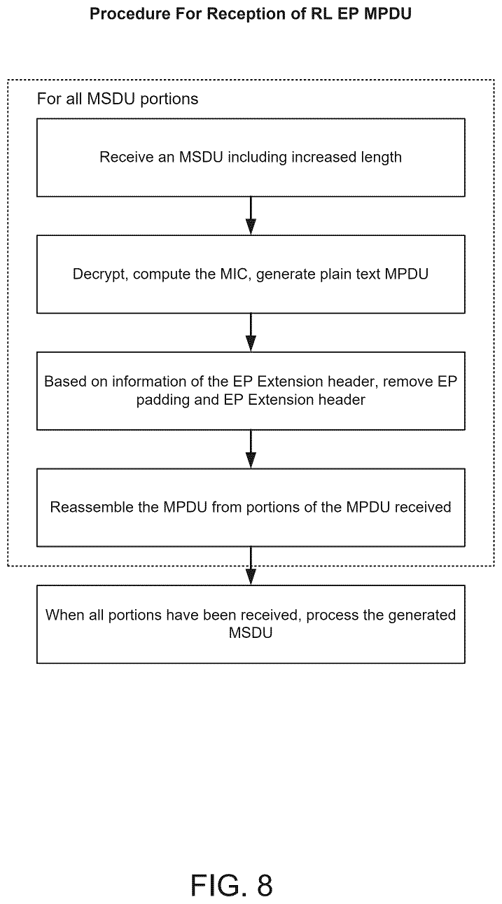

On reception, an AP (or receiving STA) processes the received RL EP MPDU. FIG. 8 shows a flow diagram of an illustrative reception procedure for an obfuscated MSDU having increased length according to aspects of the present disclosure.

For all encrypted MPDUs Proceed to decryption, compute the MIC, and generate the plain text MPDU.

Based on the information of the EP Extension header, remove the EP Padding and the EP Extension header.

Reassemble the MPDU from the portions received.

When all portions have been received process the generated MSDU as normal.

In addition, through the combined used of the EP and MSDU fragmentation, the STA may obtain an extra level of privacy. In particular, the STA may vary a setting defined by the IEEE 802.11 that sets a maximum size of a MSDU that can be transmitted on a WiFi network before it must be broken down (fragmented) into smaller pieces. That setting, the dot11Fragmentation Threshold, combined with the random final length of the frame (FL above) may be set to generate artificially long frames triggering MSDU fragmentation. This may generate random packet length patterns, increasing the difficulty of tracing a user.

### Procedure for the Obfuscation of a Segment/Fragment Length

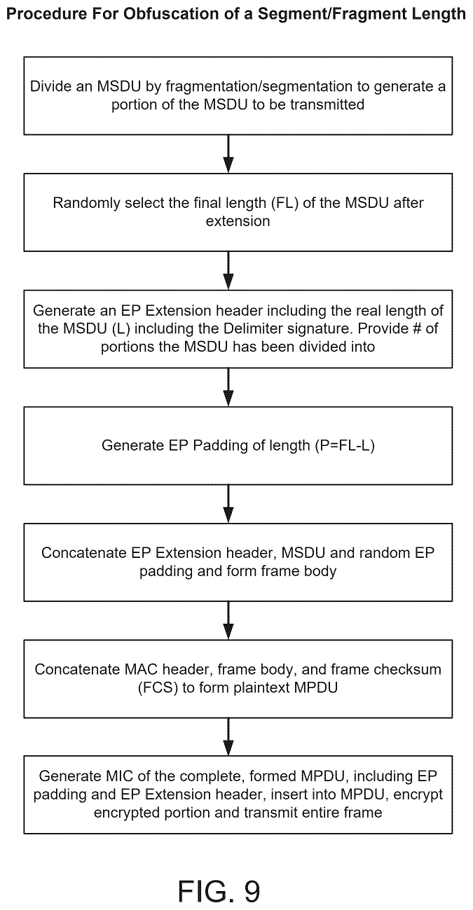

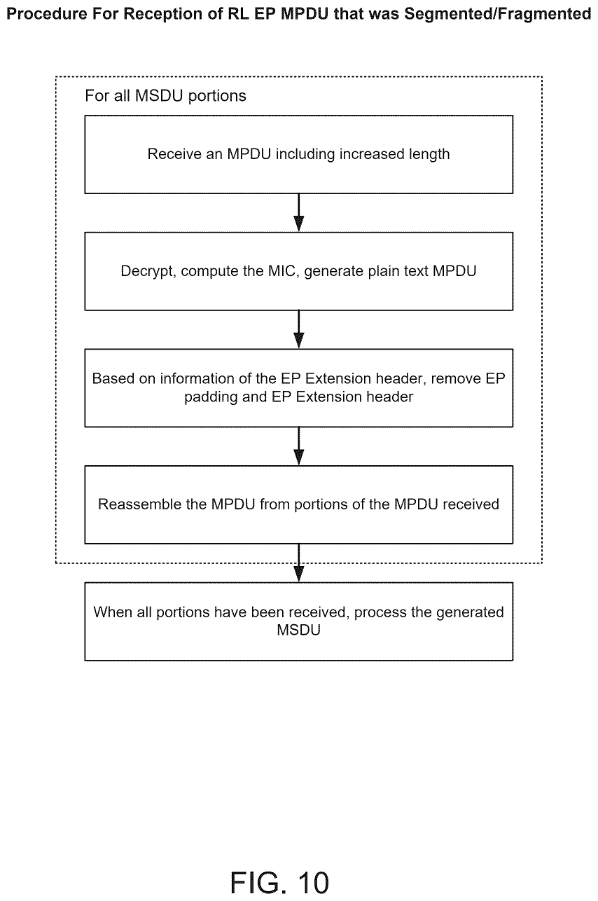

A transmitting STA may improve its privacy by obfuscating the length of the packets used for a certain traffic by dividing the MSDU into individual fragments or segments. FIG. 9 is a flow diagram and then may follow this procedure for transmission for each portion of the MSDU.

Given a portion of an MSDU to be transmitted, randomly select the final length (FL) of the MSDU after extension. This may be done through the use of one of the Pseudo Random Functions (PRFs) defined in IEEE 802.11.

While forming the plaintext MPDU, generate an EP Extension header including the real length of the MSDU (L) and including the Delimiter signature defined for this usage and provide the number of portions the MSDU has been divided into.

Generate an EP Padding of length (P=FL−L). The random padding may be obtained through multiple iterations of a PRF.

Concatenate the EP Extension header, MSDU and random padding to form the Frame Body.

Concatenate the MAC header, Frame Body, and FCS to form the plaintext MPDU.

It is important that the RL EP MPDU contains the EP Extension header and its associated EP Padding before ongoing protection. The MIC may be computed of the complete expanded MSDU, including the EP Padding and EP Extension header. This is to be able to decapsulate the plain text portion MPDU in reception.

Proceed to decryption, compute the MIC, and generate the plain text MPDU.

Based on the information of the EP Extension header, remove the EP Padding and the EP Extension header.

Reassemble the MPDU from the portions received.

When all portions have been received process the generated MSDU as normal.

In addition, through the combined used of the EP and MSDU fragmentation, the STA may obtain an extra level of protection. In particular, the STA may vary the dot11Fragmentation Threshold combined with the random final length of the frame (FL above) to generate artificially long frames triggering MSDU fragmentation. This may generate random packet length patterns, increasing the difficulty of tracing the user.

### Signaling Common Frame Size, Number of EP STAs and Epoch ID

Additional privacy protection from traffic analysis may be achieved by requiring or mandating all STAs to use a predefined, over-the-air frame size. According to aspects of the present disclosure, this may be achieved by joint use of MSDU fragmentation and random extension of MSDU length as described previously. As will be appreciated, to use a common frame size, the AP may need to advertise what the common frame size is.

In operation, this approach employs an element that may be included in different frames, to signal a common frame size, number of EP STAs and Epoch ID. Such an element allows an individual EP STA to know the total number of EP STAs rotating their MAC address in the BSS. This information may be used by EP STAs to make informed decisions related to their privacy settings. For example, an EP STA which receives from the AP information indicating there is no other EP STA or only a few EP STAs in the BSS, may refrain from using the advertised common frame size, since it may be unnecessary to protect its privacy and may provide a way to allow an observer to track the EP STA.

Although in the following definition of the information structure, we use the Element format as defined in IEEE 802.11REVme/D4.2, this information may be provided to the STA through a non-element field.

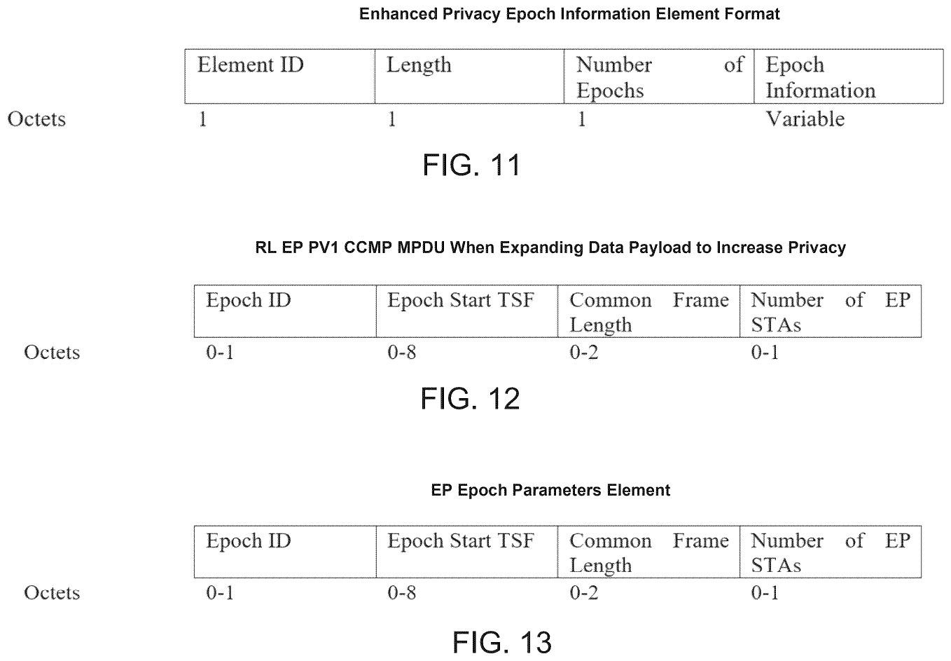

FIG. 11 shows an illustrative Enhanced Privacy Epoch Information element format according to aspects of the present disclosure. The EP Epoch Information element provides information relevant to an STA to modify its privacy behavior.

With reference to that FIG. 11 it may be observed that the element includes an Element ID field one (1) octet in length, a Length field one (1) octet in length, a Number of Epochs field one (1) octet in length, and an Epoch Information field that is variable in length. We note that the Element ID and Length fields are defined in IEEE 802.11 9.4.2.1 (General). The Number of Epochs field includes an integer indicating the number of Epoch Information fields included in the remaining of the EP Epoch Information element.

The Epoch Information field may include subfields illustratively shown in FIG. 12 including an Epoch ID subfield zero to one (0-1) octets in length, an Epoch Start Time Stamp subfield (TSF) zero to eight (0-8) octets in length, a Common Frame Length subfield zero to two (0-2) octets in length, and a Number of EP STAs subfield zero to one (0-1) subfields in length. The Epoch ID may indicate the identifier of the Epoch. The Epoch Start TSF subfield may use the Timestamp field format defined in IEEE 802.11 9.4.1.10 (Timestamp field). The Common Frame Length subfield may indicate the constant frame length to be used by all EP STAs during the Epoch identified by the Epoch ID.

The Number of EP STAs subfield indicates the number of EP STAs that may modify their privacy parameters (including rotation of MAC addresses and associated parameters) in the Epoch identified by Epoch ID. In situations where the number of EP STAs modifying their parameters is higher than 255, the Number of EP STAs field will be set to 255.

Although the design of this element considers there are multiple Epochs with different parameters, a different implementation may use a single Epoch (even without ID) and provide a single set of parameters for the EP operation of the BSS.

In other illustrative implementations, this information may be provided as part of an Action Frame.

### Protected Enhanced Data Privacy Action Frame Details

### Protected Enhanced Data Privacy Action Field

The Protected Enhanced Data Privacy Action field, located in one octet immediately after a category field, differentiates between various Protected Enhanced Data Privacy Action frames as shown in the following table, Protected Enhanced data Privacy Action Field values.

### Protected Enhanced Data Privacy Action Field Values

| Value | Meaning |
|---|---|
| 0 | FAPU Request frame |
| 1 | FAPU Response frame |
| 2 | FAPU Push frame |
| 3-255 | Reserved |

### FAPU Request Frame Format

The FAPU Request frame is an Action frame of category Protected FA. The Action field of an FAPU Request frame contains the information shown in the following Table (FAPU Request Action frame format).

### FAPU Request Action Frame Format

| Order | Information |
|---|---|
| 0 | Category |
| 1 | Protected FA Action |

The Category field is defined in IEEE 802.11bi 9.4.1.11 (Action field).

The Protected FA Action field is defined in Protected Enhanced Data Privacy Action field.

A non-AP MLD sends an FAPU Request frame to an AP MLD to request a new FA epoch for the non-AP MLD.

### FAPU Response Frame Format

The FAPU Response frame is an individually addressed Action frame of category Protected Enhanced Data Privacy. The Action field of an FAPU Response frame contains the information shown in the Table below, FAPU Response frame format).

In a given implementation, the different elements included in the Enhance Privacy Epoch Information element may be added to the FAPU Response Action field format as follows:

### FAPU Response Action Field Format

| Order | Information |
|---|---|
| 0 | Category |
| 1 | Protected FA Action |
| 2 | Status Code |
| 3 | Epoch ID* |
| 4 | FA Epoch Start TSF |
| 5 | FA AID |
| 6 | Common frame length* |
| 7 | Number of EP STAs* |

*Denotes elements added

The Category field is defined in 9.4.1.11 (Action field).

The Protected FA Action field is defined in 9.6.x.1 (Protected Enhanced Data Privacy Action field).

The Dialog Counter field is defined in 9.4.1.12 (Dialog Counter field).

The Status Code field is defined in 9.4.1.9 (Status Code field).

The Epoch ID may indicate the identifier of the Epoch as specified in 9.4.2.X Enhance Privacy Epoch Information element.

The FA Epoch Start TSF element uses the Timestamp field format defined in 9.4.1.10 (Timestamp field). The value in this field indicates the intended TSF time for which the non-AP MLD and AP MLD will transition to new FA parameters. Where this value in this element is less than the TSF time when the FAPU Response frame is transmitted, then the transition will occur at the end of the TXOP in which the FAPU Response frame is transmitted.

The FA AID element has AID format defined in 9.4.1.8 (AID). The FA AID element is the AID identifying the non-AP MLD during the FA Epoch.

The values of FA Epoch Start TSF element and FA AID element in the are combined with KDK to derive other FA parameters for the FA epoch, as described in 10.x.2.4.2 (Deriving other FA parameters).

The Common Frame Length field may indicate the constant frame length to be used by all EP STAs during the Epoch identified by the Epoch ID as specified in 9.4.2.X Enhance Privacy Epoch Information element.

The Number of EP STAs field indicates the number of EP STAs that may modify their privacy parameters (including rotation of MAC addresses and associated parameters) in the Epoch identified by Epoch ID. In case the number of EP STAs modifying their parameters is higher than 255, the Number of EP STAs field will be set to 255, as specified in 9.4.2.X Enhance Privacy Epoch Information element.

A different implementation may include directly the Enhance Privacy Epoch Information element in the FAPU Response Action field format as shown in the following Table-FAPU Response Action field format.

### FAPU Response Action Field Format

| Order | Information |
|---|---|
| 0 | Category |
| 1 | Protected FA Action |
| 2 | Status Code |
| 3 | Enhance Privacy Epoch Information element |
| 4 | FA AID |

### FAPU Push Frame Format

The FAPU Push frame is an individually addressed Action frame of category Protected Enhanced Data Privacy.

The Action field of an FAPU Push frame contains the information shown in the following Table FAPU Push Action field format.

### FAPU Push Action Field Format

| Order | Information |
|---|---|
| 0 | Category |
| 1 | Protected FA Action |
| 3 | Epoch ID* |
| 4 | FA Epoch Start TSF |
| 5 | FA AID |
| 6 | Common frame length* |
| 7 | Number of EP STAs* |

The Category field is defined in Action field.

The Protected FA Action field is defined in Protected Enhanced Data Privacy Action field.

The Epoch ID is defined in 9.6.x.1 Protected Enhanced Data Privacy Action field.

The FA Epoch Start TSF element is defined in 9.6.x.4 FAPU Response frame format.

The FA AID element is defined in 9.6.x.4 (FAPU Response frame format).

The Common frame length element is defined in 9.6.x.1 (Protected Enhanced Data Privacy Action field).

The Number of EP STAs element is defined in 9.6.x.1 (Protected Enhanced Data Privacy Action field).

A different implementation may include directly the Enhance Privacy Epoch Information element in the FAPU Push Action field format as shown in the following Table—FAPU Push Action field format.

### FAPU Push Action Field Format

| Order | Information |
|---|---|
| 0 | Category |
| 1 | Protected FA Action |
| 3 | Enhance Privacy Epoch Information* |
| 4 | FA AID |

### Mechanism to Signal Collisions for AID or MAC Addresses

Current approaches for the signaling of EP information rely on unicast messages to transport different epoch parameters that are used. For example, in one approach, Al allocations are sent in unicast to all STAs willing to change EP parameters in the next epoch. In another approach, parameters are computed based on an STA Specific Epoch Number Offset which enables the AP to signal specific STAs when the parameters used for anonymization will cause a collision in the MAC address or AID generated.

For MAC addresses, the probability of collision is not very high since each MAC address is randomized in a 46-bit space. Even in the case of a very dense AP deployment, each AP will not provide service to more than 2007 (this number is a constraint imposed by IEEE 802.11be) STAs, which number of MAC addresses may double or triple by the use of MLO, but will never reach the amount of MAC addresses possible using the 46 bits (70,368,744, 177,664) of the MAC address space.

But there is another key parameter which also needs to be changed every time an epoch starts, and which length will, cause collisions. The Association Identifier (AID) is a parameter used within a BSS to identify STAs in a compact way. It is 11 bits long (although the AID field definition is 16 bits long), but from the 2048 possibilities, only 2007 may be used. In cases where the AP is very crowded, any per-STA randomization of the AID will likely cause problems and collisions.

One possibility to handle the collisions of the AID, is to assign the AID to each STA by the AP every time randomization occurs. In scenarios where the number of STAs participating in the EP epoch is low, this solution works without incurring a large overhead, but in scenarios where the AP is providing EP support to thousands of STAs, such an approach will require sending thousands of unicast messages per epoch, which may be triggered every few minutes.

To reduce this burden, we disclose a mechanism which may be used in groupcast or broadcast frames (protected/robust or unprotected/not robust) and allows the AP to signal new values for the computation of epoch parameters to groups of STAs.

First, we define a new element which can be used to flexibly signal the epoch parameters (EP Epoch parameters) to a group or a single STA, identified by their AID. The AID used to signal the STAs that may apply the EP AID parameters assignments may be the original AID assigned to the STA during association.

FIG. 13 shows an illustrative Enhanced Privacy Epoch parameters element according to aspects of the present disclosure. With reference to that figure, it may be observed that the illustrative Enhanced Privacy Epoch parameters element according to aspects of the present disclosure includes an Element ID field that is one (1) octet in length, a Length field that is one (1) octet in length, an Element ID Extension field that is one (1) octet in length, and a List of EP AID parameter assignments field that is variable length.

The List of AID parameter assignments field includes the information required to notify the parameters per AID.

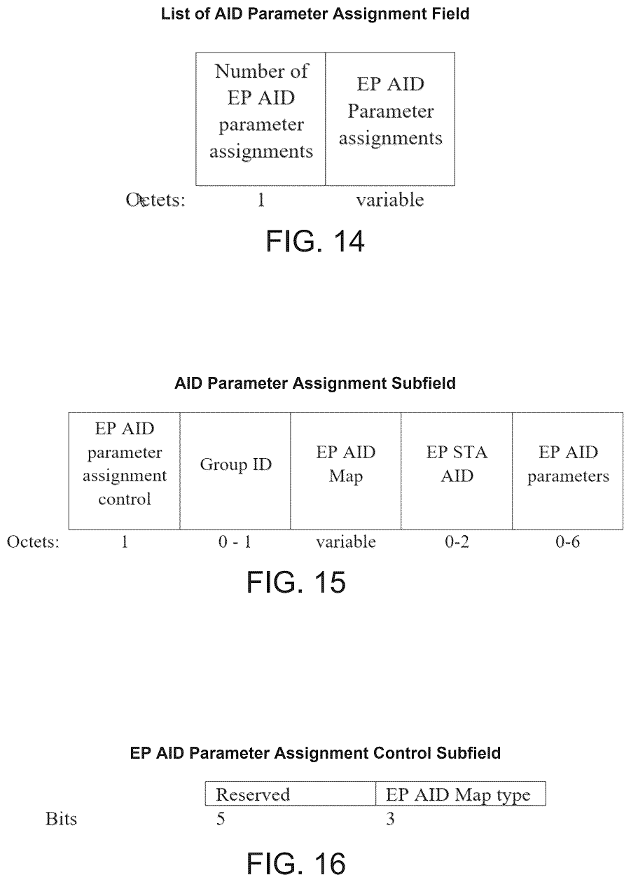

FIG. 14 shows an illustrative list of Association Identifier (AID) parameter assignments field according to aspects of the present disclosure.

As may be observed from that figure, the illustrative List of AID parameter assignments field includes a Number of EP AID parameter assignments subfield that is one (1) octet in length and an EP AID Parameter assignments field that is variable length.

The EP AID Parameter assignments subfield according to aspects of the present disclosure is shown illustratively in FIG. 15 and includes an EP AID parameter assignment control subfield that is one (1) octet in length, a Group ID subfield that is from zero-to-one (0-1) octet in length, an EP AID map subfield that is variable length, an EP STA AID subfield that is zero-to-two (0-2) octets in length, and an EP AID parameters subfield that is zero-to-six (0-6) octets in length.

FIG. 16 shows an illustrative EP AID parameter assignment subfield according to aspects of the present disclosure. The EP AID parameter assignment control subfield indicates the format of the EP AID Map and the presence of EP STA AID, and EP AID parameters subfields. As illustratively shown in FIG. 15, the structure shown includes a Reserved subfield that is five (5) bits in length and the EP AID Map type subfield that is three (3) bits in length.

The EP AID Map type indicates the format of the EP AID Map and may take the values shown in the following Table-EP AID Map type subfield values.

### EP AID Map Type Subfield Values

| Value | Description |
|---|---|
| 0 | Reserved |
| 1 | Bitmap |
| 2 | Bitmap + offset |
| 3 | Single AID |
| 4 | Offset + range |
| 5-7 | Reserved |

When the EP AID Map type is set to 1, the EP AID Map takes the form of a 2008 bits long bitmap, formatted according to the rules of the traffic indication virtual map for non-S1G PPDUs, as defined in 9.4.2.5 of IEEE 802.11REVme_D4.2.

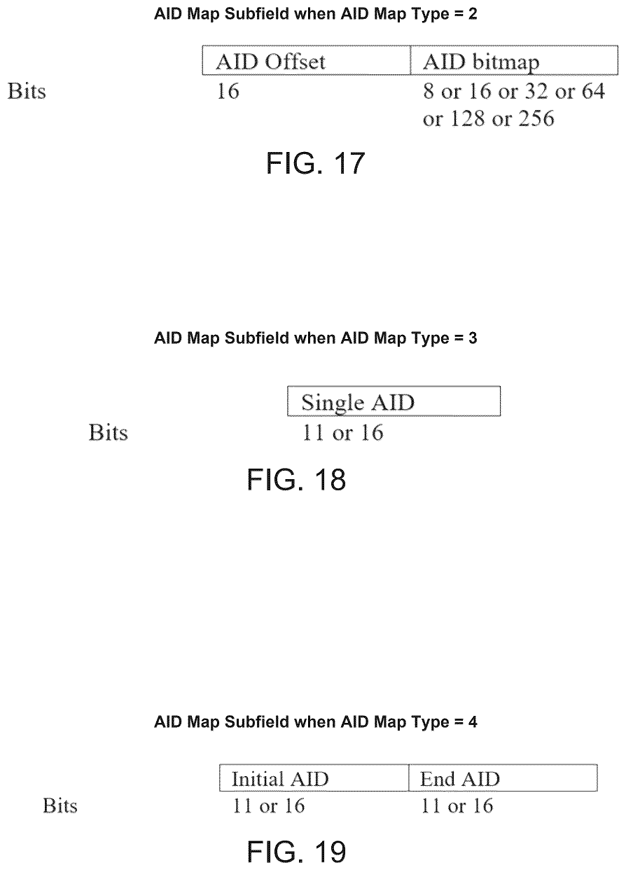

In case the EP AID Map type is set to 2, the EP AID Map takes the form shown illustratively in FIG. 17, which shows an illustrative EP AID parameter assignment control field according to aspects of the present disclosure.

As illustratively shown in that figure, an AID Offset field is 16 bits in length and an AID bitmap field which may be 8, 16, 32, 64, 128, or 256 bits in length.

The bits 0 to 11 of the AID Offset define the AID of the STA to which the MSB bit of the AID bitmap corresponds to, and the bits 12 to 15 define the length of the AID bitmap.

The EP AID Map type indicates the format of the EP AID Map and may take the values shown in the following Table—Bits 12 to 15 of Aid Offset Values.

### Bits 12 to 15 of AID Offset Values

| Bits 12 to 15 of the AID offset | |
|---|---|
| (decimal value) | Description |
| 0 | Reserved |
| 1 | AID bitmap length of 8 bits |
| 2 | AID bitmap length of 16 bits |
| 3 | AID bitmap length of 32 bits |
| 4 | AID bitmap length of 64 bits |
| 5 | AID bitmap length of 128 bits |
| 6 | AID bitmap length of 256 bits |
| 7-15 | Reserved |

The LSB of the AID bitmap may be bit 0 while the MSB may be bit 7. Bit number N indicates the STA with AID=AID Offset+N is addressed in the message. More than one STA may be addressed in the same element by setting to one multiple bits in the AID bitmap.

When EP AID Map type is set to 3, the EP AID Map may have a length of 16 bits (may be 11) and may contain a single AID. FIG. 18 shows an illustrative AID map subfield in case AID map type is set to 3 according to aspects of the present disclosure.

When EP AID Map type is set to 4, the EP AID Map contains a range of sequential AIDs. FIG. 19 shows an illustrative AID map subfield in case AID map type is set to 4 according to aspects of the present disclosure

The Group ID field indicates the identifier of the Group EDP Epoch. Value of 0 and 255 may be reserved.

The EP STA AID subfield is present in the case of EP AID Map type set to 4. In this case, the AP is signaling an individual STA which AID to use for the next epoch.

The EP AID parameters subfield contains the required information to generate the parameters for computation of the next AID and other parameters (in [1] are called FA parameters, in [2] are called Current Epoch Number).

The EP AID parameters subfield may contain a number that may be used (may be as salt) in a PRF operation (may be together with the Group ID) to get random numbers to be used as AID and MAC addresses.

Note that through the use of this number and a pairwise key between the AP and STAs, the AP is able to know which are the AID, MAC addresses and other parameters to be used in the next Epoch.

One possible example of this PRF operation may be (for the case of AID computation) AIDnew.=PRF (Key, “EXPANSION FOR AID GENERATION” |Group ID| EP AID parameters)

The EP Epoch parameters Element may be used in action frames or in beacons, probes, or any other frame to specify the epoch parameters in a compact way to multiple STAs (therefore, this element may be used in broadcast or groupcast frames). This element may include in a single message information to different groups of STAs (identified by their AID) and information to single STAs. This element will reduce the number of messages required for epoch signaling, since there will be no need to signal epoch parameters in unicast to specific STAs.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless device, the method comprising:
generating a medium access control (MAC) service data unit (MSDU), wherein a frame of the MSDU is extended by inclusion of an enhanced privacy (EP) header indicating a real size of the MSDU; and
transmitting the MSDU.

2. The method of claim 1 wherein the real size of the MSDU is an original length of the MSDU without length modification.

3. The method of claim 1, wherein the included EP header includes a length subfield containing the length of the original MSDU before being extended.

4. The method of claim 3, wherein the included EP header includes a signature subfield.

5. The method of claim 4, wherein the signature subfield includes a pattern that may be used to detect the EP header.

6. The method of claim 3, wherein the EP header includes an EP payload length field.

7. The method of claim 6, wherein the MSDU is fragmented into a plurality of MSDU fragments.

8. The method of claim 7, wherein the EP payload length field includes an indication of the number of fragments that the original MSDU has been fragmented into.

9. The method of claim 1, wherein the MSDU is extended by padding.

10. The method of claim 9, wherein the padding is random.

11. The method of claim 1, wherein the wireless device is a station (STA).

12. The method of claim 1, wherein the wireless device is an access point (AP).

13. The method of claim 1, wherein the wireless device is a vehicle.

14. The method of claim 1, wherein the wireless device is a drone.

15. The method of claim 1, wherein the wireless device is a fixed wireless access (FWA) device.

16. The method of claim 1, wherein the wireless device is an industrial device.

17. The method of claim 1, wherein the wireless device is a user equipment (UE).

18. A method for use in an access point (AP), the method comprising:
generating a transmission frame including a field containing a seed number;
wirelessly transmitting the transmission frame to a plurality of stations (STAs);
wherein the seed number may be used by at least one of the plurality STAs to generate a random number.

19. The method of claim 18 wherein the plurality of STAs is associated with the AP, each of the STAs having a unique association identifier (AID), each unique AID based on the random number.

20. The method of claim 18 wherein the plurality of STAs is associated with the AP, each of the STAs having a unique medium access control (MAC) address, each unique MAC address based on the random number.

21. The method of claim 18 wherein the transmission frame includes an extended privacy (EP) Epoch parameter element that includes the seed number.

22. The method of claim 18 wherein the transmission frame is a broadcast frame.

23. The method of claim 18 wherein the transmission frame is a multicast/groupcast frame.

24. The method of claim 18 wherein the transmission frame is any frame that specifies epoch parameters.
